(19) United States
(12) Patent Application Publication
(10) Pub. No.: US 2023/0366065 A1
(43) Pub. Date: Nov. 16, 2023

(54) TITANIUM ALLOY MEMBER AND METHOD OF PRODUCING TITANIUM ALLOY MEMBER

(71) Applicant: NIPPON STEEL CORPORATION, Tokyo (JP)

(72) Inventors: Toshiyuki OKUI, Tokyo (JP); Tomonori KUNIEDA, Tokyo (JP); Kenichi MORI, Tokyo (JP)

(73) Assignee: NIPPON STEEL CORPORATION, Tokyo (JP)

(21) Appl. No.: 18/025,935

(22) PCT Filed: Dec. 22, 2020
(86) PCT No.: PCT/JP2020/047923

§ 371 Date: Mar. 13, 2023

(51) Int. Cl. C22C 14/00; C22F 1/18; C22C 1/04

(52) U.S. Cl. CPC C22C 14/00; C22F 1/183; C22C 1/0458; C22C 2200/00

(57) ABSTRACT

A titanium alloy member by mass %, Al: 4.0% to 9.0%, one or more selected from the group consisting of Fe, Cr, and Ni: 0.5% to 2.5% in total, C: 0% to 0.100%, N: 0% to 0.100%, H: 0% to 0.100%, O: 0% to 0.500%, and a remainder including Ti and impurities, in which the titanium alloy member includes a hard part having a Vickers hardness of 350 HV or greater.

### TECHNICAL FIELD OF THE INVENTION

The present invention relates to a titanium alloy member and a method of producing the titanium alloy member.

### RELATED ART

Ti-6A1-4V-based alloys excellent in balance between strength characteristics and ductility account for about 70% of a use amount of practical titanium alloys for structure. For the Ti-6A1-4V-based alloys, a method of forming a fine martensite structure by using a quenching treatment from a β-phase can be used as a method for further improving the strength characteristics of the alloys (for example, Patent Documents 1 and 2).

Meanwhile, Ti-6A1-4V-based alloys, that are general-purpose alloys, contain expensive V as a constituent element. Therefore, replacement of V with a general-purpose element which is cheaper and more easily available, such as Fe, Cr, or Ni, has been considered (for example, Patent Document 3).

However, in a case where an α+β type titanium alloy typified by a Ti—Al—Fe-based alloy in which V is replaced with Fe is heated to a β-phase temperature range and then rapidly cooled, the strength (hardness and fatigue strength) thereof tends to be inferior to that of the Ti-6A1-4V based alloy. For example, FIG. 2 “Effect of cooling rates on Vickers hardness at room temperature in β-heat treated Ti-5Al-1Fe” of Non-Patent Document 1 shows the room temperature hardness of the sample cooled at a constant cooling rate from the β-region to room temperature. Regarding FIG. 2, Non-Patent Document 1 states that “The room temperature hardness of Ti-5Al-1Fe was the lowest hardness value of about 300 HV at a cooling rate of 0.5 to 1° C./s in the present experimental scope. The room temperature hardness slowly increased with an increase of the cooling rate and was about 330 HV at 300° C./s, and its cooling rate dependence was smaller than that of Ti-6A1-4V. This was the same tendency as in a case of Ti-5Al-2.5Sn containing only about 0.2 mass % of Fe, which is a β-stabilizing element, and a rapid increase of the hardness at a specific cooling rate (10° C./s) or greater, confirmed in Ti-6A1-4V, was not recognized”.

The reason why the strength of the Ti—Al—Fe-based alloy rapidly cooled from the β-phase tends to be inferior to that of the Ti-6A1-4V based alloy is thought to be that a metallographic structure mainly including a martensite structure cannot be formed. The reason why it is difficult to form a martensite structure in the Ti—Al—Fe-based alloy is that the diffusion rate of Fe in β-Ti is extremely fast. Even in a case where the α+β type titanium alloy is rapidly cooled from the β-phase by a general method, an α+β biphasic structure is rapidly formed due to the diffusion of Fe.

Therefore, high hardness and high fatigue properties realized in a Ti-6A1-4V-based alloy could not be realized in the α+β type titanium alloy typified by a Ti—Al—Fe-based alloy (see FIG. 2 of Non-Patent Document 1). The above problem a part of V being replaced with Fe also occurs in a case where a part of V is replaced with Cr or Ni.

### PRIOR ART DOCUMENT

### Patent Document

[Patent Document 1] Japanese Patent No. 4766408
[Patent Document 2] Japanese Patent No. 5419098
[Patent Document 3] Japanese Patent No. 3076697

### Non-Patent Document

[Non-Patent Document 1] Yoshitsugu TACHIZAWA et al., “Continuous Cooling Transformation Characteristics of Ti-5Al-1Fe”, Iron and Steel, Japan, The Iron and Steel Institute of Japan, 2016, Vol. 102, No. 5, p. 12

### DISCLOSURE OF THE INVENTION

### Problems to be Solved by the Invention

The present invention is contrived in view of the above circumstances, and an object of the present invention is to provide a titanium alloy member having a higher hardness than an α+β type Ti—Al—Fe-based alloy of the conventional art and a method of producing the titanium alloy member. Another object of the present invention is to provide a method of producing a titanium alloy member having higher fatigue properties than an α+β type Ti—Al—Fe-based alloy of the conventional art.

### Means for Solving the Problem

In order to achieve the above objects, the present invention adopts the following configurations.

(1) A titanium alloy member according to an aspect of the present invention containing, in mass %, Al: 4.0% to 9.0%, one or more selected from the group consisting of Fe, Cr, and Ni: 0.5% to 2.5% in total, C: 0% to 0.100%, N: 0% to 0.100%, H: 0% to 0.100%, O: 0% to 0.500%, and a remainder consisting of Ti and impurities, in which the titanium alloy member has a hard part having a Vickers hardness of 350 HV or greater.

(2) In the titanium alloy member according to (1), a metallographic structure of the hard part may include needle-like crystals, plate-like crystals, and a remainder in microstructure, the total amount of the plate-like crystals and the remainder in microstructure in a cross section of the hard part may be 10.0 area % or less, and the amount of the plate-like crystals in the cross section of the hard part may be 0 to 2.0 area %.

(3) In the titanium alloy member according to (1) or (2), the hard part may be disposed at a position at a depth of 0.5 mm or greater from a surface of the titanium alloy member.

(4) In the titanium alloy member according to any one of (1) to (3), the titanium alloy member may further have one or more selected from a mesh-shaped portion, an ultrathin plate-shaped portion, and a hollow-shaped portion.

(5) A method of producing a titanium alloy member according to another aspect of the present invention is a method of producing the titanium alloy member according to any one of (1) to (4), including irradiating a raw material powder containing, as a chemical composition, by mass %, Al: 4.0% to 9.0%, one or more selected from the group consisting of Fe, Cr, and Ni: 0.5% to 2.5% in total, C: 0% to 0.100%, N: 0% to 0.100%, H: 0% to 0.100%, O: 0% to 0.500%, and a remainder consisting of Ti and impurities, with laser under a condition of a heat input amount of 30.0 J/mm³ or less to melt the raw material powder, and rapidly cooling the melted raw material powder.

(6) A method of producing a titanium alloy member according to a further aspect of the present invention, including heating the titanium alloy member according to any one of (1) to (4) to an end-point temperature within a temperature range of (β-transformation point temperature−200°) C. or higher and (β-transformation point temperature −100°) C. or lower at an average heating rate of 50° C./sec or greater, hot-working the titanium alloy member within the temperature range under conditions of a strain rate of 0.10 to 10/sec and a total strain of greater than 0.50, and cooling the hot-worked titanium alloy member at an average cooling rate of 20° C./sec or greater, in which the hot working is started within 10 seconds from the time when the titanium alloy member is heated to the end-point temperature.

### Effects of the Invention

According to the present invention, it is possible to provide a titanium alloy member having a higher hardness than an α+β type Ti—Al—Fe-based alloy of the conventional art and a method of producing the titanium alloy member. Furthermore, according to the present invention, it is possible to provide a method of producing a titanium alloy member having higher fatigue properties than an α+β type Ti—Al—Fe-based alloy of the conventional art.

### BRIEF DESCRIPTION OF THE DRAWINGS

FIG. 1 is an electron micrograph of Test Example 3.

FIG. 2 is an electron micrograph of Test Example 3 and is a photograph taken with a visual field different from that of FIG. 1.

FIG. 3 is a flowchart of a method of evaluating a structure of a hard part.

### EMBODIMENTS OF THE INVENTION

According to the conventional art, it was not possible to adjust the Vickers hardness of a part or the whole of a member made of a Ti—Al—Fe-based alloy to 350 HV or greater. The reason for this is thought to be that the diffusion rate of Fe in β-Ti is extremely fast. Even in a case where the Ti—Al—Fe-based alloy is heated to a β-single phase region (a temperature range in which the entire metallographic structure transforms into a β-phase) and then rapidly cooled, Fe rapidly diffuses, and thus the metallographic structure rapidly transforms into an α+β biphasic structure. Therefore, it is thought that the hardness in a case where the Ti—Al—Fe-based alloy is rapidly cooled from the β-single phase region is inferior to that of a Ti-6A1-4V-based alloy that can obtain a martensite structure by being rapidly cooled from the β-single phase in the same manner. It is thought that this fact also applies to a Ti alloy containing Ni and/or Cr in addition to or in place of Fe.

The inventors have conducted studies on a method of cooling an alloy at a rate faster than the diffusion rate of an alloying element such as Fe, and focused on a three-dimensional additive manufacturing technology. The three-dimensional additive manufacturing technology is a process enabling near net shaping without normal melting, forging, and cutting processes. As described above, the three-dimensional additive manufacturing technology does not utilize a normal melting process. Therefore, it has been found that microsegregation of an alloying element such as Fe is less likely to occur in the three-dimensional additive manufacturing. In addition, in a Ti—Al—Fe-based alloy member produced by using the three-dimensional additive manufacturing technology and optimizing the producing conditions, it was possible to achieve a Vickers hardness of 350 HV or greater, that could not be realized by a normal producing process. The reason for this is presumed to be that after the member solidifies, cooling is completed faster than diffusion of Fe in Ti, and for this reason, the β-phase at a high temperature is cooled while containing a large amount of Fe, a hard martensite structure is formed, and the amount of the hard phase in the metallographic structure is increased. In addition, the same results were obtained with a titanium alloy member containing Cr and/or Ni instead of Fe.

However, in some cases, cracks occurred in a member produced by applying the three-dimensional additive manufacturing technology to a Ti—Al—Fe-based alloy. Here, in a case of using an electron beam type three-dimensional additive manufacturing method in which the cooling rate after solidification is relatively slow, it was possible to suppress cracks, but a Vickers hardness of 350 HV or greater, that is an object of the present invention, could not be achieved. Meanwhile, in a case of using a laser type three-dimensional additive manufacturing method in which the cooling rate after solidification is fast, cracks occurred in many cases. A member in which cracks occurred is extremely inferior in appearance, strength, and the like, and the cracks progress by an external force and reach fracture. Accordingly, the member cannot be put into practical use.

It was also not possible to suppress the occurrence of cracks in a titanium alloy member containing Cr and/or Ni instead of Fe. There is no example in which the occurrence of cracks is regarded as a problem in a titanium alloy member obtained by applying a casting method to a Ti—Al—Fe-based alloy. Cracks are thought to be a problem peculiar to a case where the three-dimensional additive manufacturing technology is applied to a Ti—Al—Fe-based alloy.

Therefore, the inventors have conducted intensive studies on a method for improving the hardness of a titanium alloy member without the occurrence of cracks. As a result, it was possible to avoid the occurrence of cracks by controlling the laser output in the three-dimensional additive manufacturing to an extremely small value.

Hereinafter, a titanium alloy member according to an embodiment of the present invention will be described.

The titanium alloy member according to the present embodiment contains, as a chemical composition, by mass %, Al: 4.0% to 9.0%, one or more selected from the group consisting of Fe, Cr, and Ni: 0.5% to 2.5% in total, C: 0% to 0.100%, N: 0% to 0.100%, H: 0% to 0.100%, O: 0% to 0.500%, and a remainder consisting of Ti and impurities, and has a hard part having a Vickers hardness of 350 HV or greater. In the present embodiment, the “titanium alloy member” is deemed to be a member including no cracks (for example, cracks exceeding 20% of the maximum thickness of a portion including a hard part) that become a problem in use of the member. This is because a member including cracks that become a problem in use of the member cannot be put into practical use, and therefore cannot be regarded as a member in the ordinary sense.

Hereinafter, the chemical composition of the titanium alloy member according to the present embodiment will be described. Unless otherwise specified, “%” means “mass %”.

Al: 4.0% to 9.0%

In order to secure the strength of the titanium alloy member, the lower limit of the Al content is 4.0% or greater. In a case where the Al content is less than 4.0%, the Vickers hardness is reduced, and it becomes difficult to obtain desired strength characteristics. In addition, in a case where the Al content is greater than 9.0%, there is a concern that the ductility of the titanium alloy member may be significantly reduced. Therefore, the Al content is preferably in a range of 4.0% to 9.0%. The Al content may be 4.2% or greater, 4.5% or greater, 4.8% or greater, or 5.0% or greater. The Al content may be 8.0% or less, 7.0% or less, 6.5% or less, or 6.0% or less.

One or More Selected from Group Consisting of Fe, Cr, and Ni: 0.5% to 2.5% in Total

The titanium alloy member contains one or more selected from the group consisting of Fe, Cr, and Ni. All of these elements are used to secure the strength in the titanium alloy member according to the present embodiment. Therefore, in the titanium alloy member according to the present embodiment, the total amount of the elements is predetermined.

The total amount of Fe, Cr, and Ni is adjusted to 0.5% or greater. In a case where the total amount of Fe, Cr, and Ni is less than 0.5%, the Vickers hardness of the titanium alloy member is reduced, and it becomes difficult to obtain desired strength characteristics. In addition, in a case where the total amount of Fe, Cr, and Ni is greater than 2.5%, the β-phase is stabilized, and it becomes difficult to obtain desired strength characteristics. Furthermore, in a case where the total amount of Fe, Cr, and Ni is greater than 2.5% and the amount of Fe is excessive, there is a concern that an intermetallic compound phase (TiFe, TiFe₂), which is an equilibrium phase, may be likely to be formed. In a case where the intermetallic compound phase is included in the titanium alloy member, there is a concern that the intermetallic compound may brittlely fracture by thermal expansion due to a temperature change, and this may lead to the occurrence of cracks or an extreme reduction of fatigue properties. In addition, in a case where the total amount of Fe, Cr, and Ni is greater than 2.5% and the amount of Cr or Ni is excessive, an intermetallic compound phase (Ti₂Ni, TiCr₂), which is an equilibrium phase, is likely to be formed. Thus, there is a concern that the intermetallic compound phase may brittlely fracture by thermal expansion due to a temperature change, and this may lead to the occurrence of cracks or an extreme reduction of fatigue properties. Therefore, the total amount of Fe, Cr, and Ni is in a range of 0.5% to 2.5%. The total amount of Fe, Cr, and Ni may be 0.6% or greater, 0.7% or greater, 0.8% or greater, or 1.0% or greater. The total amount of Fe, Cr, and Ni may be 2.2% or less, 2.0% or less, 1.8% or less, 1.7% or less, or 1.5% or less.

The individual amounts of Fe, Cr, or Ni is not particularly limited as long as the above-described regulation of the total amount is satisfied. For example, the amount of one or two elements of Fe, Cr, or Ni may be 0% as long as the above-described regulation of the total amount is satisfied.

The titanium alloy member may contain C as a chemical composition. The titanium alloy member according to the present embodiment can achieve the objects without containing C. Therefore, the C content may be 0%. Meanwhile, in order to reduce the refining cost and secure the strength, for example, about 0.100% of C is allowed in the titanium alloy member. The C content may be 0.001% or greater, 0.003% or greater, or 0.005% or greater. The C content may be 0.080% or less, 0.050% or less, or 0.010% or less.

The titanium alloy member may contain N as a chemical composition. The titanium alloy member according to the present embodiment can achieve the objects without containing N. Therefore, the N content may be 0%. Meanwhile, in order to reduce the refining cost and secure the strength, for example, about 0.100% of N is allowed in the titanium alloy member. The N content may be 0.001% or greater, 0.002% or greater, or 0.003% or greater. The N content may be 0.080% or less, 0.050% or less, or 0.010% or less.

The titanium alloy member may contain H as a chemical composition. The titanium alloy member according to the present embodiment can achieve the objects without containing H. Therefore, the H content may be 0%. Meanwhile, in order to reduce the refining cost, for example, about 0.100% of H is allowed in the titanium alloy member. The H content may be 0.001% or greater, 0.002% or greater, or 0.003% or greater. The H content may be 0.080% or less, 0.050% or less, or 0.010% or less.

The titanium alloy member may contain O as a chemical composition. The titanium alloy member according to the present embodiment can achieve the objects without containing O. Therefore, the O content may be 0%. Meanwhile, in order to reduce the refining cost and secure the strength, for example, about 0.500% of O is allowed in the titanium alloy member. The O content may be 0.010% or greater, 0.050% or greater, or 0.100% or greater. The O content may be 0.300% or less, 0.250% or less, or 0.200% or less.

The remainder of the chemical composition of the titanium alloy member according to the present embodiment includes Ti and impurities. The impurities mean, for example, components that are mixed due to various factors such as raw materials or production steps in the industrial production of a titanium alloy member, and are allowed within a range that does not adversely affect the titanium alloy member according to the present embodiment. Examples of the components mixed by various factors include Cl, Mn, Mg, Si, V, Cu, Sn, Mo, Nb, Ru, and Pd.

Next, the hard part of the titanium alloy member according to the present embodiment will be described. The titanium alloy member according to the present embodiment has a hard part having a Vickers hardness of 350 HV or greater. That is, the Vickers hardness of a part or the whole of the titanium alloy member according to the present embodiment is 350 HV or greater. Therefore, the titanium alloy member according to the present embodiment has a high strength and can be used as various mechanical structural parts. The hardness of the hard part may be 360 HV or greater, 380 HV or greater, or 400 HV or greater.

The size, shape, and position of the hard part, the range occupied by the hard part in the member, and the like are not particularly limited and can be selected depending on the use of the titanium alloy member. All regions of the titanium alloy member may be hard parts. Meanwhile, in the titanium alloy member, the hard part may be provided only in a region where the strength is required, and the Vickers hardness in the other region may be suppressed to be less than 350 HV. For example, in a case where the titanium alloy member is produced by a three-dimensional additive manufacturing technology, it is possible to flexibly design the size, shape, and position of the hard part, the range occupied by the hard part in the member, and the like. For example, the hard part may be disposed at a position at a depth of 0.5 mm or greater, a depth of 0.8 mm or greater, or a depth of 1.0 mm or greater from the surface of the titanium alloy member. Here, the “depth” is the shortest distance between the hard part and the surface of the titanium alloy member.

The Vickers hardness of the titanium alloy member is measured as follows: the member is cut at any portion, the cut surface is polished, a Vickers indenter is pressed and fitted into the cut surface to form an indentation, and the size of the indentation is measured. The load for pressing and fitting the Vickers indenter is, for example, 5 kgf. A titanium alloy member having one or more portions where the Vickers hardness is determined to be 350 HV or greater is a titanium alloy member having a hard part having a Vickers hardness of 350 HV or greater. In addition, a titanium alloy member in which the center of an indentation at a portion where the Vickers hardness is determined to be 350 HV or greater is 0.5 mm or greater away from the outer edge of a cut surface of the titanium alloy member is a titanium alloy member in which a hard part having a Vickers hardness of 350 HV or greater is disposed at a position at a depth of 0.5 mm or greater from the surface.

As long as the chemical composition is within the above-described range and a hard part of which the Vickers hardness is 350 HV or greater is provided, other configurations of the titanium alloy member according to the present embodiment are not particularly limited. Hereinafter, a more suitable form of the titanium alloy member will be exemplified.

For example, in the titanium alloy member according to the present embodiment, the metallographic structure of the hard part may include needle-like crystals, plate-like crystals, and a remainder in microstructure, the total amount of the plate-like crystals and the remainder in microstructure in a cross section of the hard part may be 10.0 area % or less, and the amount of the plate-like crystals in the cross section of the hard part may be 0 to 2.0 area %.

The plate-like crystals are crystals judged to be an α-phase by an X-ray diffraction method or an EBSD method, and mean both
crystals having a short side width of greater than 5 μm, measured by cross section observation, and
crystals having a short side width of 5 μm or less, measured by cross section observation, and judged to form a laminated aggregate form by cross section observation.

The needle-like crystals mean crystals, which is judged to be an α-phase by an X-ray diffraction method or an EBSD method, and which is other than the plate-like crystals.

The remainder in microstructure means a structure judged to be a phase other than the α-phase by an X-ray diffraction method or an EBSD method.

[Needle-Like Crystals]

In the present embodiment, the needle-like crystals are also called a so-called widmannstatten structure. In a case where the needle-like crystals are analyzed by an X-ray diffraction method or an EBSD method, the crystals are discriminated to be an α-phase. However, the needle-like crystals have an extremely high Vickers hardness as compared to an ordinary α-phase. Therefore, in the titanium alloy member according to the present embodiment, it is presumed that the needle-like crystals are not an α-phase, but an α′-martensite structure solidified without diffusion of an alloying element such as Fe.

In a case where the metallographic structure of the hard part of the titanium alloy member according to the present embodiment mainly includes needle-like crystals, the hard part has a Vickers hardness further higher than that of an α+β type titanium alloy of the conventional art.

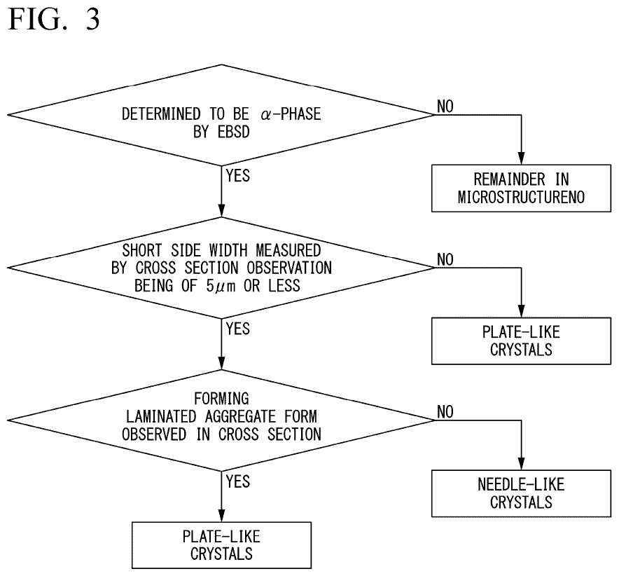

The needle-like crystals and the plate-like crystals to be described later are distinguished from each other based on the shapes thereof. The needle-like crystals are crystals having a smaller short side width than the plate-like crystals. However, it is not easy to accurately grasp the widths of the needle-like crystals and the plate-like crystals. The reason for this is that in a case where the needle-like crystals and the plate-like crystals are observed in a cross section of the titanium alloy member, the measured values of the widths of the crystals in the cut surface change depending on the angle formed between the cut surface and the crystals. The needle-like crystals and the plate-like crystals are discriminated based on the flowchart shown in FIG. 3, and the details thereof will be described later.

[Plate-Like Crystals]

The plate-like crystals are a structure formed due to the transformation of a site lacking β-stabilizing elements such as Fe into an α-phase, resulting from the diffusion of a part of the β-stabilizing elements in rapid cooling of the titanium alloy member according to the present embodiment from a β-single phase temperature range. In a case where the plate-like crystals are analyzed by an X-ray diffraction method or an EBSD method, the crystals are discriminated to be an α-phase. That is, in a case where the plate-like crystals and the needle-like crystals are evaluated by an X-ray diffraction method or an EBSD method, both are evaluated to be an α-phase, and thus both cannot be discriminated by the X-ray diffraction method or the EBSD method. The plate-like crystals and the needle-like crystals are discriminated based on the apparent short side width and the aggregated state thereof.

The plate-like crystals have a lower Vickers hardness than the needle-like crystals. Therefore, the area ratio of the plate-like crystals in the hard part is preferably 2.0 area % or less. The area ratio of the plate-like crystals in the hard part may be 1.8 area % or less, 1.5 area % or less, or 1.0 area % or less. From the viewpoint of further increasing the strength of the titanium alloy member, the smaller the amount of the plate-like crystals in the hard part, the better. Therefore, the lower limit of the area ratio of the plate-like crystals in the hard part may be 0 area %. Meanwhile, the area ratio of the plate-like crystals in the hard part may be 0.1 area % or greater, 0.2 area % or greater, or 0.5 area % or greater.

[Remainder in Microstructure]

A part or the whole of the remainder in microstructure of the hard part of the titanium alloy member according to the present embodiment is a β-phase. Examples of the remainder in microstructure other than the β-phase include a site where phase identification by EBSD is not possible due to residual strain or the like. The remainder in microstructure other than the β-phase is extremely small. The β-phase is soft. Accordingly, from the viewpoint of further increasing the strength of the titanium alloy member, the smaller the remainder in microstructure in the hard part, the better. In the present embodiment, the total amount of the plate-like crystals and the remainder in microstructure in the hard part is preferably 10.0 area % or less. By adjusting the total amount of the plate-like crystals and the remainder in microstructure in the hard part to 10.0 area % or less, the area ratio of the hard needle-like crystals is increased, and thus a further higher Vickers hardness can be obtained. The area ratio of the remainder in microstructure in the hard part may be 9.0 area % or less, 8.5 area % or less, or 8.0 area % or less. The smaller the remainder in microstructure, the better. Accordingly, the lower limit of the area ratio may be 0 area %. Meanwhile, the area ratio of the remainder in microstructure in the hard part may be 2.5 area % or greater, 3.0 area % or greater, or 4.0 area % or greater.

The crystal structure in the hard part of the titanium alloy member according to the present embodiment is measured by using the observation of a metallographic structure of a cross section and electron backscatter diffraction (EBSD) in combination. As shown in FIG. 3, first, by using EBSD, the needle-like crystals and the plate-like crystals, which are determined to be an α-phase, are distinguished from the structures other than the α-phase, which are assumed as the remainder in microstructure. Next, the needle-like crystals and the plate-like crystals are distinguished from each other by observing the metallographic structure of the cross section. Hereinafter, a method of evaluating the crystal structure will be described in detail.

First, a test piece having a cross section of the hard part as an observation section is collected. The structure evaluation described below may be performed on the cross section of the hard part after the position of the hard part is roughly specified by measuring the hardness by the above-described method. Meanwhile, after the structure evaluation described below is performed on the portion presumed to be the hard part, the hardness of the portion may be measured by the above-described method to determine whether the portion is the hard part.

Next, the measurement is performed using EBSD at a measurement interval of 1.0 μm and an acceleration voltage of 15 kV with a rectangular region of 3 mm in length and 3 mm in width as a visual field at a measurement portion on the observation section of the test piece. A pixel in the EBSD is 1.0 μm square. A pixel having a confidence interval (CI) value of 0.1 or less was regarded as noise and removed.

From the obtained measurement results, a pattern quality (PQ) map and a phase map are created by Kikuchi pattern analysis, and the α-phase and the β-phase are separated and extracted. The Kikuchi pattern analysis is performed only on the α-phase and the β-phase.

From the obtained phase maps, the area ratio of each of the α-phase and the β-phase is obtained. In addition, the area ratio of the area classified into neither the α-phase nor the β-phase is obtained as the area ratio of the remainder in microstructure.

Next, in order to distinguish whether the crystal grains identified as the α-phase from the phase map of the EBSD measurement have a plate-like structure including an α-phase or a needle-like structure including α′-martensite, the cross section of the hard part is etched to expose the crystal structure. The cross section to be observed is any cross section parallel to a thickness direction, and for etching, for example, an aqueous solution at room temperature containing 2.0 mass % of a hydrofluoric acid and 6.0 mass % of a nitric acid is applied to the cross section of the hard part to cause a reaction for about 2 to 10 seconds. Crystal grains having a short side width of greater than 5 μm are extracted, and the area of the crystal grains having a short side width of greater than 5 μm is obtained. Crystals having an apparent short side width of greater than 5 μm in the cross section are determined to be plate-like crystals. The thickness direction of the titanium alloy member according to the present embodiment is a direction in which the lamination progresses in the three-dimensional additive manufacturing, and refers to a direction perpendicular to the powder bed. In the direction perpendicular to the thickness direction (that is, the direction parallel to the powder bed in the three-dimensional additive manufacturing), all the directions are thought to be equivalent. Accordingly, the cross section for structure observation may be any cross section parallel to the thickness direction.

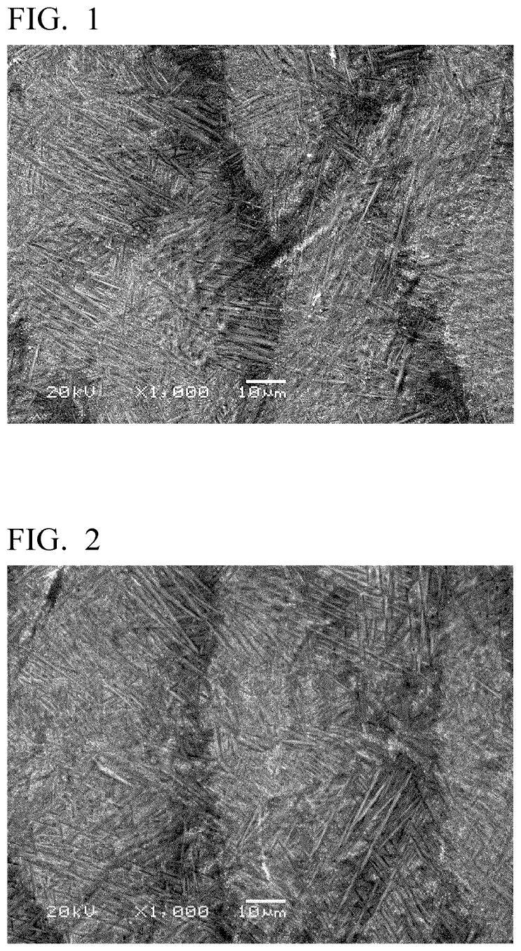

Regarding the crystal grains having an apparent short side width of 5 μm or less in the cross section, whether the crystal grains are needle-like crystals or plate-like crystals cannot be determined only by the short side width of the crystal grains. The reason for this is that in a case where the observation section is formed perpendicular to the surface of the plate-like crystals, the short side width of the plate-like crystals is apparently 5 μm or less. Meanwhile, by evaluating the aggregate form of the crystals, the needle-like crystals and the plate-like crystals can be distinguished from each other. The needle-like crystals extend in various directions as shown in FIGS. 1 and 2. The plate-like crystals have an aggregate form in which flat sheet-like crystal grains are laminated. Therefore, in a case where the observation section is formed perpendicular to the surface of the plate-like crystals, the plate-like crystals have a regularly arranged appearance in the observation section. For example, in the region denoted by the determination symbol “α_{L}” in FIG. 3(d) of Non-Patent Document, the plate-like crystals are regularly arranged in the observation section formed perpendicular to the surface of the plate-like crystals. Therefore, the crystal grains that are regularly arranged can be presumed to be plate-like crystals. In this manner, it is possible to presume whether the crystal grains are needle-like crystals or plate-like crystals based on whether the crystal grains have a laminated aggregate form or an aggregate form other than the laminated aggregate form.

Next, the shape of the titanium alloy member according to the present embodiment will be described. Since the titanium alloy member according to the present embodiment is produced by using the three-dimensional additive manufacturing technology as described later, the shape thereof is not particularly limited. For example, the titanium alloy member may have a simple shape such as a plate shape, a rod shape, or a tubular shape. In contrast, the titanium alloy member may have a complicated component shape having one or more selected from a mesh-shaped portion, an ultrathin plate-shaped portion, and a hollow-shaped portion. The titanium alloy member according to the present embodiment has a high strength and its shape can be flexibly designed. Accordingly, the titanium alloy member can be suitably used as a member for structure. The size of the titanium alloy member is also not particularly limited, but may have, for example, a portion having a thickness of 1 mm or greater, and a hard part may be provided at this portion.

Next, an example of a method of producing the titanium alloy member will be described. The method of producing the titanium alloy member is not particularly limited, but the titanium alloy member is preferably produced by using, for example, a laser type three-dimensional additive manufacturing technology.

The titanium alloy member according to the present embodiment is produced as follows. First, a raw material powder layer is formed by depositing a raw material powder having the above-described chemical composition as an average composition. Next, a part of the raw material powder layer is melted by laser beams and then solidified to form a solidified layer. Next, a new raw material powder layer is laminated on the raw material powder layer after the melting and solidification. The new raw material powder layer is subjected to melting by laser beams and solidification. In this manner, the lamination of the raw material powder layer, and the melting by laser beams and solidification are repeated a plurality of times, and then the raw material powder in an unsolidified state is removed. Accordingly, a titanium alloy member in which the solidified layers subjected to melting by laser beams and solidification are laminated is produced. By adjusting the irradiation range of laser beams, the titanium alloy member can be made to have a desired shape.

In a case where the raw material powder layer is irradiated with laser beams, the raw material powder is melted by the laser beams and becomes a liquid metal. Then, the laser beams are moved to another location. Therefore, the temperature of the melted liquid metal is reduced, and a solidified layer including a β-phase is formed. Even after that, the temperature of the solidified layer is continuously reduced, and reaches an α+β phase region. Here, in a case where the solidified layer is rapidly cooled, a martensite structure is formed without formation of an α+β biphasic state. By adjusting the cooling rate of the solidified layer to a high rate of, for example, 1,000 K/sec or greater, diffusion of Fe is suppressed, and a hard part having a Vickers hardness of 350 HV or greater is formed.

However, in a case where the above-described producing method is applied to the raw material powder having the components of the titanium alloy member according to the present embodiment, cracks occur in the titanium alloy member. The reason for this is presumed to be that according to the conditions for conducting normal three-dimensional additive manufacturing, since the temperature of the melted liquid metal rises too much, the temperature difference between the melted site and the site around the melted site is large, and the difference in thermal contraction amount inside the titanium alloy member, accompanied by cooling after solidification, is large. In order to suppress cracks, the laser is required to be applied under the condition of a heat input amount of 30.0 J/mm³ or less to melt the raw material powder. The heat input amount is a value lower than usual, which is disadvantageous in consideration of the production efficiency. However, in the method of producing the titanium alloy member according to the present embodiment, it is extremely desirable to employ the above condition from the viewpoint of suppressing cracks.

As the raw material powder, for example, a powder of 10 to 50 μm in average grain size and of about 5 to 15 μm in standard deviation of grain sizes is used. Such a raw material powder is produced by a method such as a gas atomizing method. The raw material powder may be a titanium alloy powder having the above-described chemical composition, or a mixed powder prepared by blending a metal titanium powder, a metal aluminum powder, an iron powder, a metal chromium powder, a metal nickel powder, and an alloy powder containing a part of each of the powders so that the above-described chemical composition is obtained.

The raw material powder is deposited on a substrate to form the raw material powder layer. The substrate on which the first raw material powder layer is laminated may be a bed floor of a three-dimensional additive manufacturing apparatus, and the substrate on which the second and subsequent raw material powder layers are laminated may be the raw material powder layer formed previously. The thickness of one raw material powder layer may be, for example, 10 to 50 μm.

Next, laser beams are applied from above the raw material powder layer at a predetermined scanning speed. The laser beam irradiation conditions are important for controlling the cooling rate after solidification. In the present embodiment, the heat input amount (J/mm³) represented by P/(V·d·t)×10⁶ is limited to 30.0 (J/mm³) or less. In a case where the heat input amount is greater than 30.0 (J/mm³), the thermal contraction amount accompanied by cooling after solidification of the raw material powder layer increases, and cracks occur due to the strain difference between the solidified portion and the portion around the solidified portion. Here, V is the scanning speed (mm/s) of laser beams, P is the output (W) of laser beams, d is the pitch (μm) of the locus of laser beams during laser beam scanning, and t is the average penetration depth (μm) of the raw material powder layer.

The scanning speed V is preferably in a range of 400 to 900 mm/s. The output P of laser beams may be in a range of 70 to 150 W or in a range of 80 to 120 W. The pitch d of laser beams is preferably in a range of 50 to 150 μm. The average penetration depth t is preferably in a range of 50 to 150 μm.

The beam diameter of laser beams may be in a range of 30 to 70 μm, 40 to 60 μm, or 45 to 55 μm.

In addition, the atmosphere during laser beam irradiation is preferably an inert gas atmosphere such as argon in order to prevent oxidation of the titanium alloy.

Through the above steps, a titanium alloy member having a hard part having a Vickers hardness of 350 HV or greater can be produced.

According to the titanium alloy member of the present embodiment, the metallographic structure mainly includes needle-like crystals, and the needle-like crystals are a structure having a higher Vickers hardness than the α-phase of titanium. Accordingly, high strength characteristics can be exhibited. The needle-like crystals of the titanium alloy member according to the present embodiment are presumed to be an α′-martensite structure.

In addition, the titanium alloy member according to the present embodiment can realize a titanium alloy member that has a chemical composition containing no V and containing any one or more of Fe, Cr, and Ni, Al, and a remainder consisting of Ti and impurities, has needle-like crystals presumed to be an α′-martensite structure even without containing V, and has a higher strength than an α+β type Ti—Al—Fe-based alloy of the conventional art.

As described above, the titanium alloy member according to the present embodiment is extremely useful as a mechanical structural part by itself. Meanwhile, it is also extremely useful that the titanium alloy member according to the present embodiment is used as an intermediate material and a titanium alloy member having characteristics different from those of the titanium alloy member according to the present embodiment is produced. Specifically, it has been found that a titanium alloy member having a random crystal orientation and fine equiaxed crystal grains is obtained by subjecting the titanium alloy member according to the present embodiment to hot working by rapid heating and subsequent rapid cooling. The obtained titanium alloy member had a high strength and an excellent fatigue strength.

A method of producing a titanium alloy member according to another embodiment of the present invention, obtained based on the above findings, will be described. The method of producing a titanium alloy member according to another embodiment of the present invention has heating the above-described titanium alloy member according to the present embodiment to an end-point temperature within a temperature range of β-transformation point temperature −200°) C. or higher and (β-transformation point temperature −100°) C. or lower at an average heating rate of 50° C./sec or greater, hot-working the titanium alloy member within the temperature range under the conditions of a strain rate of 0.10 to 10/sec and a total strain of greater than 0.50, and cooling the hot-worked titanium alloy member at an average cooling rate of 20° C./sec or greater. Hereinafter, a titanium alloy member used as an intermediate material in the above producing method will be referred to as “first titanium alloy member”, and a titanium alloy member obtained by the above producing method will be referred to as “second titanium alloy member” for convenience sake.

First, the first titanium alloy member, which is an intermediate material, is heated to an end-point temperature within a temperature range of β-transformation point temperature−200°) C. or higher and (β-transformation point temperature −100°) C. or lower at an average heating rate of 50° C./sec or greater. By rapidly heating the intermediate material at an average heating rate of 50° C./sec or greater, the intermediate material can be heated to a high temperature range suitable for hot working before diffusion of an alloying element such as Fe from the α′-martensite structure, and thus a fine α+β structure can be directly formed from the α′-martensite structure. In a case where the average heating rate is low during heating of the intermediate material, an alloying element such as Fe diffuses from the α′-martensite structure during temperature increase. Thus, transformation into an α-phase occurs and coarse α-crystal grains grow. Accordingly, the fatigue strength of the second titanium alloy member is reduced. The faster the average heating rate, the better, and the average heating rate is more preferably 60° C./sec or greater and even more preferably 80° C./sec or greater. The average heating rate mentioned here is an average heating rate at which the surface temperature of the intermediate material reaches the end-point temperature from 700° C. That is, the value obtained by subtracting 700° C. from the end-point temperature is divided by the time required for the surface temperature of the intermediate material to reach the end-point temperature from 700° C., and the resulting value obtained is the average heating rate.

The end-point temperature (highest heating temperature) after rapid heating is preferably in a range of (β-transformation point temperature−200°) C. or higher and (β-transformation point temperature−100°) C. or lower. In a case where the end-point temperature is lower than (β-transformation point temperature−200°) C., the load required for the subsequent hot working is increased, and the deformability of the material is reduced. Therefore, voids and cracks occur inside the material, and the fatigue properties of the second titanium alloy member are reduced. In addition, in a case where the end-point temperature is higher than (β-transformation point temperature −100°) C., the strength and the fatigue properties are reduced. The reason for this is presumed to be that a part of the α′-martensite structure is transformed into an α+β structure and grows during working of the first titanium alloy member, so that a fine α+β structure cannot be directly formed from the α′-martensite structure, the α-phase excessively grows, and the average equivalent circle diameter of the equiaxed crystal grains is thus increased. The end-point temperature is more preferably in a range of (β-transformation point temperature −150°) C. or higher and (β-transformation point temperature −100°) C. or lower. The end-point temperature is the surface temperature of the intermediate material.

The heated first titanium alloy member is then hot-worked. The hot working may be performed once or twice or more. In addition, the hot working is preferably started as soon as the surface temperature of the intermediate material reaches the end-point temperature, and for example, the hot working is preferably started within 10 seconds from the time when the intermediate material reaches the end-point temperature. In a case where the time from the time when the end-point temperature is reached to the time when the hot working is started is increased, it is thought that an alloying element such as Fe diffuses from the α′-martensite structure, transformation into an α+β-phase occurs, and a preferable metallographic structure cannot thus be obtained. More preferably, the hot working may be started within 5 seconds from the time when the end-point temperature is reached.

The strain rate during hot working is preferably in a range of 0.10 to 10/sec. Ina case where the strain rate is less than 0.10/sec, the strength and fatigue properties of the second titanium alloy member are reduced. The reason for this is presumed to be that a part of the α′-martensite structure is transformed into an α+β structure and grows during hot working of the first titanium alloy member, so that the α-phase excessively grows, and the average equivalent circle diameter of the equiaxed crystal grains is thus increased. The greater the strain rate, the better. However, in a case where the strain rate is greater than 10/sec, the effect of improving the strength and fatigue properties is saturated. Therefore, the upper limit of the strain rate during hot rolling is 10/sec or less.

In addition, the total strain amount in a case where the hot working is performed once or twice or more is preferably greater than 0.50. In a case where the total strain amount is 0.50 or less, the fatigue properties of the titanium alloy member are reduced. The reason for this is presumed to be that sufficient nucleation cannot be obtained when a fine α+β structure is directly formed from the α′-martensite structure, and a part of the structure remains in a non-recrystallized state.

The first titanium alloy member is cooled immediately after hot working. Accordingly, the structure is frozen. The cooling method may be water cooling. The average cooling rate during cooling is preferably 20° C./sec or greater. In a case where the average cooling rate is less than 20° C./sec, the fatigue properties of the titanium alloy member are reduced. The reason for this is presumed to be that the average equivalent circle diameter of the equiaxed crystal grains is increased during cooling. The average cooling rate is an average cooling rate from the start of cooling to 700° C. That is, the average cooling rate is a value obtained by dividing the temperature difference between the surface temperature of the intermediate material at the start of cooling and 700° C. by the time required for the surface temperature of the intermediate material to decrease to 700° C. from the start of cooling of the intermediate material. The cooling end temperature is not particularly limited, but is preferably, for example, 700° C. or lower.

The time required from the end of hot working to the start of cooling is preferably as short as possible, and is, for example, within 5 seconds, and more preferably within 3 seconds. In a case where the time required from the end of hot working to the start of cooling is increased, the fatigue properties of the second titanium alloy member are reduced. The reason for this is presumed to be that the average equivalent circle diameter of the equiaxed crystal grains is increased. The “start of cooling” is a time when accelerated cooling for the first titanium alloy member which has been hot-worked is started. In a case where the method for accelerated cooling is water cooling, the time when the accelerated cooling is started is a time when the application of cooling water to the first titanium alloy member which has been hot-worked is started.

By sequentially performing the above steps, a second titanium alloy member is obtained.

### EXAMPLES

Hereinafter, the present invention will be described in more detail with examples. The present invention is, of course, not limited to the following examples, and can also be appropriately changed and implemented within a range that can be adapted to the gist which has been described and will be described, and all of the changes are included in the technical scope of the present invention.

### Example 1: First Titanium Alloy Member

A titanium alloy powder having the chemical composition shown in Table 1 was prepared as a raw material powder. The average grain size of the raw material powder was as shown in Table 1. In addition, the standard deviation of grain sizes of the raw material powder was in a range of 5 to 15 μm. In Table 1 and other tables to be described below, values outside the range of the present invention were underlined.

Using the prepared raw material powder, a first titanium alloy member was produced by a three-dimensional additive manufacturing method. Specifically, first, the raw material powder was deposited to form a raw material powder layer having a thickness of 30 μm. Then, a part of the raw material powder layer was melted by laser beams and then solidified to form a solidified layer. Next, a new raw material powder layer having a thickness of 30 μm was laminated on the raw material powder layer after the melting and solidification. The new raw material powder layer was subjected to melting by laser beams and solidification. In this manner, the lamination of the raw material powder layer, and the melting by laser beams and solidification were repeated a plurality of times, and then the raw material powder in an unsolidified state was removed. Accordingly, a first titanium alloy member in which the solidified layers subjected to melting by laser beams and solidification were laminated was produced. Hereinafter, in this experiment, the first titanium alloy member will be simply referred to as a titanium alloy member.

The titanium alloy member had a shape having: a rod-like evaluation portion having a length of 32 mm, a width of 6.25 mm, and a thickness of 4.0 mm; and gripping portions having a maximum width of 15 mm and a length of 19 mm provided at both ends of the evaluation portion in a longitudinal direction. Here, the thickness direction is a direction in which the lamination progresses in the three-dimensional additive manufacturing, and refers to a direction perpendicular to the powder bed.

The laser beam irradiation conditions were as shown in Table 2. In addition, the beam diameter of the laser beam was 50 μm, and the atmosphere during laser beam irradiation was an argon gas atmosphere.

The crystal structure of the obtained titanium alloy member was measured.

First, a test piece having a cross section parallel to the thickness direction as an observation section was collected from a width of 3.13 mm of the evaluation portion of the titanium alloy member. The measurement portion on the observation section was a position at a depth of t/4 in the direction of the thickness t of the evaluation portion. Next, the measurement was performed using EBSD at a measurement interval of 2.0 μm and an acceleration voltage of 15 kV with a rectangular region of 3 mm in length and 3 mm in width as a visual field at the measurement portion on the observation section of the test piece. From the obtained measurement results, a pattern quality (PQ) map and a phase map were created by Kikuchi pattern analysis, and a β-phase was extracted to obtain an area ratio of β-crystal grains in the metallographic structure. The area ratio of β-crystal grains was defined as an area ratio of the remainder in microstructure. In all the samples, the remainder in microstructure other than the β-crystal grains was not confirmed.

In the present embodiment, since all the directions are thought to be equivalent in the direction perpendicular to the thickness direction, any cross section parallel to the thickness direction may be employed as the observation section. In this example, the test piece was prepared from the central position of the width of the evaluation portion of the titanium alloy member.

In order to distinguish whether the crystal grains identified as the α-phase from the phase map of the EBSD measurement have a plate-like structure including an α-phase or a needle-like structure including α′-martensite, the observation section of the same sample was etched to expose the crystal structure. The cross section to be observed was a cross section parallel to the thickness direction as in the EBSD measurement. An aqueous solution at room temperature containing 2.0 mass % of a hydrofluoric acid and 6.0 mass % of a nitric acid was applied to a cross section of a hard part and reacted for about 2 to 10 seconds to etch the observation section of the test piece, and thus the crystal structure of the hard part was exposed. Based on the procedure shown in FIG. 3, needle-like crystals and plate-like crystals were discriminated.

In addition, the Vickers hardness of each titanium alloy member was measured. The load for pressing and fitting a Vickers indenter was 5 kgf.

The results are shown in Table 3.

TABLE 1

| | | | | | | | | | | Grain Size |
|---|---|---|---|---|---|---|---|---|---|---|
| | Chemical Composition | | | | | | | | | of Raw |
| | (mass %) of Raw Material | | | | | | | | | Material Powder |
| Test | Remainder: Impurities | | | | | | | | | Average Grain |
| Examples | Al | Fe | Ni | Cr | C | N | H | O | Ti | Size (μm) |
| 1 | 5.0 | 0.4 | — | — | 0.007 | 0.006 | 0.003 | 0.183 | bal. | 28.8 |
| 2 | 5.0 | 0.5 | — | — | 0.007 | 0.005 | 0.004 | 0.183 | bal. | 29.3 |
| 3 | 5.0 | 1.0 | — | — | 0.006 | 0.004 | 0.004 | 0.201 | bal. | 28.7 |
| 4 | 5.0 | 2.5 | — | — | 0.006 | 0.005 | 0.002 | 0.158 | bal. | 28.9 |
| 5 | 5.0 | 2.6 | — | — | 0.007 | 0.004 | 0.003 | 0.156 | bal. | 28.7 |
| 6 | 6.0 | 1.0 | — | — | 0.005 | 0.005 | 0.003 | 0.175 | bal. | 28.6 |
| 7 | 6.0 | 2.5 | — | — | 0.006 | 0.004 | 0.003 | 0.199 | bal. | 29.4 |
| 8 | 5.0 | — | 1.0 | — | 0.006 | 0.005 | 0.002 | 0.152 | bal. | 29.1 |
| 9 | 5.0 | — | | 1.0 | 0.006 | 0.004 | 0.003 | 0.192 | bal. | 28.6 |
| 10 | 4.0 | 1.0 | — | — | 0.006 | 0.004 | 0.003 | 0.174 | bal. | 28.6 |
| 11 | 9.0 | 1.0 | — | — | 0.005 | 0.005 | 0.003 | 0.163 | bal. | 28.9 |
| 12 | 5.0 | 1.0 | — | 1.0 | 0.007 | 0.005 | 0.002 | 0.154 | bal. | 28.8 |
| 13 | 5.0 | — | 0.5 | 1.0 | 0.005 | 0.004 | 0.003 | 0.155 | bal. | 28.7 |
| 14 | 5.0 | 1.0 | — | — | 0.006 | 0.004 | 0.004 | 0.201 | bal. | 28.7 |
| 15 | 5.0 | 1.0 | — | — | 0.006 | 0.004 | 0.004 | 0.201 | bal. | 28.7 |
| 16 | 5.0 | 1.0 | — | — | 0.006 | 0.004 | 0.004 | 0.201 | bal. | 28.7 |
| 17 | 5.0 | 1.0 | — | — | 0.006 | 0.004 | 0.004 | 0.201 | bal. | 28.7 |
| 18 | 5.0 | 1.0 | — | — | 0.006 | 0.004 | 0.004 | 0.201 | bal. | 28.7 |
| 19 | 5.0 | 1.0 | — | — | 0.006 | 0.004 | 0.004 | 0.201 | bal. | 28.7 |
| 20 | 5.0 | 1.0 | — | — | 0.006 | 0.004 | 0.004 | 0.201 | bal. | 28.7 |
| 21 | 5.0 | 1.0 | — | — | 0.006 | 0.004 | 0.004 | 0.201 | bal. | 28.7 |
| 22 | 5.0 | 1.0 | — | — | 0.006 | 0.004 | 0.004 | 0.201 | bal. | 28.7 |
| 23 | 5.0 | 1.0 | — | — | 0.006 | 0.004 | 0.004 | 0.201 | bal. | 28.7 |
| 24 | 5.0 | 1.0 | — | — | 0.006 | 0.004 | 0.004 | 0.201 | bal. | 28.7 |
| 25 | 5.0 | 1.0 | — | — | 0.005 | 0.005 | 0.002 | 0.176 | bal. | — |

TABLE 2

| | Additive Manufacturing Conditions | | | | | | |
|---|---|---|---|---|---|---|---|
| | Thickness | | | | | | |
| | of Raw | | | Scanning | | | |
| | Material | Laser | | Speed | Pitch d | Average | Heat |
| | Powder | Beam | Laser | V of | of Locus | Penetration | Input |
| Test | Layer | Diameter | Output | Beams | of Beams | Depth t | Amount |
| Examples | (μm) | (μm) | P (W) | (mm/s) | (μm) | (μm) | (J/mm³) |
| 1 | 30 | 50 | 95 | 650 | 100 | 75 | 19.5 |
| 2 | 30 | 50 | 95 | 650 | 100 | 75 | 19.5 |
| 3 | 30 | 50 | 95 | 650 | 100 | 75 | 19.5 |
| 4 | 30 | 50 | 95 | 650 | 100 | 75 | 19.5 |
| 5 | 30 | 50 | 95 | 650 | 100 | 75 | 19.5 |
| 6 | 30 | 50 | 95 | 650 | 100 | 75 | 19.5 |
| 7 | 30 | 50 | 95 | 650 | 100 | 75 | 19.5 |
| 8 | 30 | 50 | 95 | 650 | 100 | 75 | 19.5 |
| 9 | 30 | 50 | 95 | 650 | 100 | 75 | 19.5 |
| 10 | 30 | 50 | 95 | 650 | 100 | 75 | 19.5 |
| 11 | 30 | 50 | 95 | 650 | 100 | 70 | 20.9 |
| 12 | 30 | 50 | 95 | 650 | 100 | 75 | 19.5 |
| 13 | 30 | 50 | 95 | 650 | 100 | 75 | 19.5 |
| 14 | 30 | 50 | 95 | 650 | 75 | 75 | 26.0 |
| 15 | 30 | 50 | 75 | 900 | 75 | 50 | 22.2 |
| 16 | 30 | 50 | 95 | 400 | 100 | 100 | 23.8 |
| 17 | 30 | 50 | 95 | 400 | 75 | 100 | 31.7 |
| 18 | 30 | 50 | 95 | 650 | 100 | 75 | 19.5 |
| 19 | 30 | 50 | 95 | 650 | 100 | 75 | 19.5 |
| 20 | 30 | 50 | 95 | 650 | 100 | 75 | 19.5 |
| 21 | 30 | 50 | 95 | 650 | 100 | 75 | 19.5 |
| 22 | 30 | 50 | 95 | 650 | 100 | 75 | 19.5 |
| 23 | 30 | 50 | 95 | 650 | 100 | 75 | 19.5 |
| 24 | 30 | 50 | 95 | 650 | 100 | 75 | 19.5 |
| 25 | — | — | — | — | — | — | — |

TABLE 3

| | First Titanium Alloy Member | | | | | |
|---|---|---|---|---|---|---|
| | | | | Total Area | | |
| | | | | of Plate-Like | | |
| | Area of | Crystals | Area of | Crystals and | | |
| | Needle-Like | Area of | β-Phase of | β-Phase of | | |
| Test | Crystals | Plate-Like | Remainder | Remainder | Hardness | |
| Examples | (%) | (%) | (%) | (%) | (HV) | Remarks |
| 1 | 87.9 | 4.0 | 8.1 | 12.1 | 330 | Comparative Example |
| 2 | 92.1 | 2.0 | 5.9 | 7.9 | 354 | Invention Example |
| 3 | 96.8 | 0.0 | 3.2 | 3.2 | 389 | Invention Example |
| 4 | 92.5 | 0.0 | 7.5 | 7.5 | 412 | Invention Example |
| 5 | 87.4 | 0.0 | 12.6 | 12.6 | 346 | Comparative Example |
| 6 | 92.5 | 0.0 | 7.5 | 7.5 | 392 | Invention Example |
| 7 | 91.4 | 0.0 | 8.6 | 8.6 | 408 | Invention Example |
| 8 | 97.4 | 0.0 | 2.6 | 2.6 | 385 | Invention Example |
| 9 | 97.3 | 0.0 | 2.7 | 2.7 | 394 | Invention Example |
| 10 | 96.6 | 0.0 | 3.4 | 3.4 | 375 | Invention Example |
| 11 | 94.6 | 2.0 | 3.4 | 5.4 | 412 | Invention Example |
| 12 | 91.8 | 0.0 | 8.2 | 8.2 | 401 | Invention Example |
| 13 | 93.2 | 0.0 | 6.8 | 6.8 | 378 | Invention Example |
| 14 | 95.2 | 0.0 | 4.8 | 4.8 | 374 | Invention Example |
| 15 | 94.9 | 0.0 | 5.1 | 5.1 | 401 | Invention Example |
| 16 | 96.3 | 0.0 | 3.7 | 3.7 | 388 | Invention Example |
| 17 | 87.4 | 2.0 | 10.6 | 12.6 | 342 | Comparative Example |
| 18 | 96.8 | 0.0 | 3.2 | 3.2 | 389 | Invention Example |
| 19 | 96.8 | 0.0 | 3.2 | 3.2 | 389 | Invention Example |
| 20 | 96.8 | 0.0 | 3.2 | 3.2 | 389 | Invention Example |
| 21 | 96.8 | 0.0 | 3.2 | 3.2 | 389 | Invention Example |
| 22 | 96.8 | 0.0 | 3.2 | 3.2 | 389 | Invention Example |
| 23 | 96.8 | 0.0 | 3.2 | 3.2 | 389 | Invention Example |
| 24 | 96.8 | 0.0 | 3.2 | 3.2 | 389 | Invention Example |
| 25 | 84.2 | 4.0 | 11.8 | 15.8 | 330 | Comparative Example |

As shown in Table 3, in the titanium alloy members of Test Examples 2 to 4, 6 to 16, and 18 to 24, the chemical composition satisfied the range of the present invention, and the heat input amount was 30.0 J/mm³ or less. Accordingly, a hard part having a Vickers hardness of 350 HV or greater was formed.

FIGS. 1 and 2 show electron micrographs of Test Example 3. FIGS. 1 and 2 are photographs taken with different visual fields. As shown in FIGS. 1 and 2, it is found that the metallographic structure of Test Example 3 mainly includes needle-like crystals.

Meanwhile, in Test Example 1, the heat input amount during producing was 30.0 J/mm³ or less, but the amount of one or more elements selected from the group consisting of Fe, Cr, and Ni was less than the range of the present invention. Therefore, a hard part having a Vickers hardness of 350 HV or greater was not obtained.

In addition, in Test Example 5, the heat input amount during producing was 30.0 J/mm³ or less, but the amount of one or more elements selected from the group consisting of Fe, Cr, and Ni was greater than the range of the present invention. Therefore, a hard part having a Vickers hardness of 350 HV or greater was not obtained.

In Test Example 17, the chemical composition satisfied the range of the present invention, but the heat input amount was greater than 30.0 J/mm³. Therefore, a hard part having a Vickers hardness of 350 HV or greater was not obtained.

In addition, in Test Example 25, a titanium alloy including the chemical composition shown in Table 2 was heated to a β-phase temperature range, and then rapidly cooled at a cooling rate of 300° C./sec. Therefore, the additive manufacturing conditions in Test Example 25 are indicated by “−”. In Test Example 25, the chemical composition satisfied the range of the present invention, but a hard part having a Vickers hardness of 350 HV or greater was not obtained. The reason for this is presumed to be that the cooling rate is insufficient.

### Example 2: Second Titanium Alloy Member

A first titanium alloy member having a length of 80 mm, a width of 25 mm, and a thickness of 25 mm was produced by the same procedure as in Test Examples 1 to 25 described above. The first titanium alloy member was used as an intermediate material and hot-worked under the conditions shown in Table 4, and thus a second titanium alloy member was produced. Specifically, the intermediate material was rapidly heated to reach the end-point temperature, and then hot-worked once or more and rapidly cooled immediately after the end of the hot-working. The time required from the time when the surface temperature of the intermediate material reached the end-point temperature to the time when the hot working was started was within 5 seconds, and the time required from the end of hot working to the start of cooling was also within 5 seconds. In this manner, second titanium alloy members of Test Examples 1 to 25 were produced. Hereinafter, in this experiment, the second titanium alloy member will be simply referred to as a titanium alloy member.

In addition, the fatigue strength of each of the titanium alloy members of Test Examples 1 to 25 was measured. The target for the measurement of the fatigue strength was a round bar test piece having an annular cross section collected from the titanium alloy members. The longitudinal direction of a parallel portion of the round bar test piece coincided with the longitudinal direction of the titanium alloy member. In addition, polishing was performed so that the surface roughness of the parallel portion of the round bar test piece was equal to or greater than polishing paper #600. A rotary bending fatigue test was performed using an Ono type rotary bending tester under the conditions of 360 rpm and a stress ratio R=−1.0 in the air at 25° C. The maximum stress causing no fatigue fracture even in a case where stress was repeatedly loaded up to 1×10⁷ times was defined as a fatigue strength. The results are shown in Table 5. A titanium alloy member having a fatigue strength of 625 MPa or greater was evaluated as acceptable in terms of fatigue strength. Values outside of the acceptable range were underlined.

Furthermore, the tensile strength of each of the titanium alloy members of Test Examples 1 to 25 was measured. The target for the measurement of the tensile strength was an ASTM half-size tensile test piece (width of parallel portion: 6.25 mm, length of parallel portion: 32 mm, gauge length: 25 mm) collected from the titanium alloy member. The longitudinal direction of a parallel portion of the tensile test piece coincided with the longitudinal direction of the titanium alloy member. The measurement was performed at a strain rate of 0.5%/min up to a strain of 1.5%, and then performed at a strain rate of 30%/min up to fracture in the air at 25° C. The tensile strength at this time was measured. The results are shown in Table 5. A titanium alloy member having a tensile strength of 1,100 MPa or greater was evaluated as acceptable in terms of tensile strength. Values outside of the acceptable range were underlined.

As shown in Table 5, in the titanium alloy members of Test Examples 2 to 4, 6 to 16, and 18 to 20, the chemical composition satisfied the range of the present invention, and the producing conditions satisfied the range of the present invention. Accordingly, a high fatigue strength and a high tensile strength were exhibited.

Meanwhile, in Test Example 1, the amount of one or more elements selected from the group consisting of Fe, Cr, and Ni was small, and the intermediate material did not have a hard part. As a result, the titanium alloy member of Test Example 1 was insufficient in fatigue strength and tensile strength. In addition, in Test Example 5, the amount of one or more elements selected from the group consisting of Fe, Cr, and Ni was excessive, and the intermediate material did not have a hard part. As a result, the titanium alloy member of Test Example 5 was insufficient in fatigue strength and tensile strength. In Test Example 17, since the heat input amount during producing of the intermediate material was greater than 30.0 J/mm³, the intermediate material did not have a hard part. As a result, the titanium alloy member of Test Example 17 was insufficient in fatigue strength and tensile strength.

In Test Example 21, since the average heating rate before hot working of the intermediate material was low, the fatigue strength and the tensile strength were insufficient. In Test Example 22, since the strain rate during hot working of the intermediate material was low, the fatigue strength and the tensile strength were insufficient. In Test Example 23, since the total strain amount during hot working of the intermediate material was small, the fatigue strength and the tensile strength were insufficient. In Test Example 24, since the average cooling rate after hot working was low and a long time was required for cooling, the fatigue strength and the tensile strength were insufficient.

In Test Example 25, the intermediate material was not produced by a laser type three-dimensional additive manufacturing method, but a cast product of a titanium alloy was used as the intermediate material. Therefore, in Test Example 25, the fatigue strength and the tensile strength were insufficient.

TABLE 4

| | Hot Working Conditions | | | | | | |
|---|---|---|---|---|---|---|---|
| | Average | | β- | | | | |
| | Temperature | End- | Transformation | | | Number | Average |
| | Raising | point | Point | Strain | Total | of Hot | Cooling |
| Test | rate | temperature | Temperature | Rate | Strain | Working | Rate |
| Examples | (° C./s) | (° C.) | (° C.) | (/sec) | Amount | Operations | (° C./s) |
| 1 | 80 | 905 | 1025 | 0.5 | 0.69 | 1 | 50 |
| 2 | 80 | 903 | 1023 | 0.5 | 0.69 | 1 | 50 |
| 3 | 80 | 890 | 1010 | 0.5 | 0.69 | 1 | 50 |
| 4 | 80 | 853 | 973 | 0.5 | 0.69 | 1 | 50 |
| 5 | 80 | 850 | 970 | 0.5 | 0.69 | 1 | 50 |
| 6 | 80 | 907 | 1027 | 0.5 | 0.69 | 1 | 50 |
| 7 | 80 | 870 | 990 | 0.5 | 0.69 | 1 | 50 |
| 8 | 80 | 900 | 1020 | 0.5 | 0.69 | 1 | 50 |
| 9 | 80 | 900 | 1020 | 0.5 | 0.69 | 1 | 50 |
| 10 | 80 | 877 | 997 | 0.5 | 0.69 | 1 | 50 |
| 11 | 80 | 944 | 1064 | 0.5 | 0.69 | 1 | 50 |
| 12 | 80 | 866 | 986 | 0.5 | 0.69 | 1 | 50 |
| 13 | 80 | 878 | 998 | 0.5 | 0.69 | 1 | 50 |
| 14 | 80 | 890 | 1010 | 0.5 | 0.69 | 1 | 50 |
| 15 | 80 | 890 | 1010 | 0.5 | 0.69 | 1 | 50 |
| 16 | 80 | 890 | 1010 | 0.5 | 0.69 | 1 | 50 |
| 17 | 80 | 890 | 1010 | 0.5 | 0.69 | 1 | 50 |
| 18 | 80 | 910 | 1010 | 0.5 | 0.69 | 1 | 50 |
| 19 | 80 | 825 | 1010 | 0.5 | 0.69 | 1 | 50 |
| 20 | 80 | 890 | 1010 | 0.3 | 1.1 | 2 | 100 |
| 21 | 40 | 890 | 1010 | 0.5 | 0.69 | 1 | 50 |
| 22 | 80 | 890 | 1010 | 0.05 | 0.69 | 1 | 50 |
| 23 | 80 | 890 | 1010 | 0.5 | 0.29 | 1 | 50 |
| 24 | 80 | 890 | 1010 | 0.5 | 0.69 | 1 | 10 |
| 25 | 80 | 890 | 1010 | 0.5 | 1.1 | 2 | 50 |

TABLE 5

| | Second Titanium Alloy Member | | |
|---|---|---|---|
| Test | Fatigue Strength | Tensile Strength | |
| Examples | (MPa) | (MPa) | Remarks |
| 1 | 547 | 960 | Comparative Example |
| 2 | 741 | 1300 | Example |
| 3 | 734 | 1287 | Example |
| 4 | 738 | 1294 | Example |
| 5 | 587 | 1030 | Comparative Example |
| 6 | 738 | 1295 | Example |
| 7 | 733 | 1286 | Example |
| 8 | 743 | 1303 | Example |
| 9 | 723 | 1269 | Example |
| 10 | 691 | 1219 | Example |
| 11 | 744 | 1312 | Example |
| 12 | 728 | 1283 | Example |
| 13 | 731 | 1290 | Example |
| 14 | 734 | 1288 | Example |
| 15 | 728 | 1277 | Example |
| 16 | 733 | 1286 | Example |
| 17 | 575 | 1008 | Comparative Example |
| 18 | 743 | 1303 | Example |
| 19 | 724 | 1270 | Example |
| 20 | 735 | 1290 | Example |
| 21 | 533 | 935 | Comparative Example |
| 22 | 536 | 940 | Comparative Example |
| 23 | 553 | 970 | Comparative Example |
| 24 | 526 | 923 | Comparative Example |
| 25 | 530 | 912 | Comparative Example |

1. A titanium alloy member comprising, as a chemical composition, in mass %:
Al: 4.0% to 9.0%;
one or more selected from the group consisting of Fe, Cr, and Ni: 0.5% to 2.5% in total;
C: 0% to 0.100%;
N: 0% to 0.100%;
H: 0% to 0.100%;
O: 0% to 0.500%; and
a remainder including Ti and impurities,
wherein the titanium alloy member includes a hard part having a Vickers hardness of 350 HV or greater.

2. The titanium alloy member according to claim 1,
wherein a metallographic structure of the hard part includes
needle-like crystals,
plate-like crystals, and
a remainder in microstructure,
a total amount of the plate-like crystals and the remainder in microstructure in a cross section of the hard part is 10.0 area % or less, and
an amount of the plate-like crystals in the cross section of the hard part is 0 to 2.0 area %.

3. The titanium alloy member according to claim 1,
wherein the hard part is disposed at a position at a depth of 0.5 mm or greater from a surface of the titanium alloy member.

4. The titanium alloy member according to claim 1,
wherein the titanium alloy member further includes one or more selected from a mesh-shaped portion, an ultrathin plate-shaped portion, and a hollow-shaped portion.

5. A method of producing the titanium alloy member of claim 1, comprising:
irradiating a raw material powder containing, as a chemical composition, by mass %,
Al: 4.0% to 9.0%,
one or more selected from the group consisting of Fe, Cr, and Ni: 0.5% to 2.5% in total,
C: 0% to 0.100%,
N: 0% to 0.100%,
H: 0% to 0.100%,
O: 0% to 0.500%, and
a remainder including Ti and impurities, with laser under a condition of a heat input amount of 30.0 J/mm³ or less to melt the raw material powder; and
rapidly cooling the melted raw material powder.

6. A method of producing a titanium alloy member, the method comprising:
heating the titanium alloy member comprising, as a chemical composition, in mass %:
Al: 4.0% to 9.0%;
one or more selected from the group consisting of Fe, Cr, and Ni: 0.5% to 2.5% in total;
C: 0% to 0.100%;
N: 0% to 0.100%;
H: 0% to 0.100%;
O: 0% to 0.500%; and
a remainder including Ti and impurities,
wherein the titanium alloy member includes a hard part having a Vickers hardness of 350 HV or greater
to an end-point temperature within a temperature range of β-transformation point temperature −200°) C. or higher and (β-transformation point temperature −100°) C. or lower at an average heating rate of 50° C./sec or greater;
hot-working the titanium alloy member within the temperature range under conditions of a strain rate of 0.10 to 10/sec and a total strain of greater than 0.50; and
cooling the hot-worked titanium alloy member at an average cooling rate of 20° C./sec or greater,
wherein the hot working is started within 10 seconds from the time when the titanium alloy member is heated to the end-point temperature.

7. The titanium alloy member according to claim 2,
wherein the hard part is disposed at a position at a depth of 0.5 mm or greater from a surface of the titanium alloy member.

8. The titanium alloy member according to claim 2,
wherein the titanium alloy member further includes one or more selected from a mesh-shaped portion, an ultrathin plate-shaped portion, and a hollow-shaped portion.

9. The titanium alloy member according to claim 3,
wherein the titanium alloy member further includes one or more selected from a mesh-shaped portion, an ultrathin plate-shaped portion, and a hollow-shaped portion.

10. The titanium alloy member according to claim 7,
wherein the titanium alloy member further includes one or more selected from a mesh-shaped portion, an ultrathin plate-shaped portion, and a hollow-shaped portion.
